(19) United States
(12) Patent Application Publication
(10) Pub. No.: US 2004/0147691 A1
(43) Pub. Date: Jul. 29, 2004

(54) Solid epoxidic cycloaliphatic hydroxylate resins, preparation process, and compositions of hardenable powerbase paints containing the said resins

(76) Inventors: Sergio Gazzea, Romano D'Ezzclino (IT); Robertinio Chinellato, Chirignano (IT); Roberto Cavalieri, Padova (IT); Carlo Fumagalli, Albano Sant' Alessandro (IT); Roberto Pirola, Dalmine (IT); Barbara Carantani, Bergamo (IT)

Correspondence Address: Darby & Darby, Post Office Box 5257, New York, NY, 10150-5257, US

(21) Appl. No.: 10/467,775

(22) PCT Filed: Jan. 28, 2002
(86) PCT No.: PCT/IT02/00040

(30) Foreign Application Priority Data
Feb. 9, 2001 (IT) MI20001A000259

(51) Int. Cl. C08G 59/02

(52) U.S. Cl. 525/523

(57) ABSTRACT

The invention concerns solid epoxidic cycloaliphatic hydroxylate resins, a process for the production thereof and compositions of hardenable powder-base paints containing the said resins. In particular, the said procedure enables solid epoxidic cycloaliphatic hydroxylate resins to be prepared with Tg≧35° C., epoxidic equivalent weight between 190 and 3,000, preferably between 250 and 2,000, Hydroxyl Number between 15 and 200 mg KOH/g, numeric molecular weight between 800 and 15,000, preferably lying between 1,000 and 10,000.

The present invention relates to solid epoxidic cycloaliphatic hydroxylate resins, a process for the preparation thereof and compositions of hardenable powder-base paints containing the said resins.

Epoxidic cycloaliphatic resins are utilised in major fields such as electric/electronic equipment and devices, in the winding and painting of filaments.

Epoxy cycloaliphatic resins are mainly utilised, in the framework of paints, in coatings for high-performance outdoor applications, thanks to their high resistance to weathering and ultraviolet rays.

Powder coating is becoming progressively more widespread since the solution avoids the use of solvents and the related pollution problems. Epoxy cycloaliphatic resins are used as cross-linking agents combined with polyester carboxylate resins in the case of hardenable powder coatings.

Tri-glycidyl-isocyanate (TGIC) is the most commonly used epoxy cross-linking agent. This product performs well, but has toxicity problems and is a suspected mutagenic agent, since the AMES test gives positive results.

The industry is actively searching for substitutes for TGIC-based paints, which are therefore non-toxic.

The U.S. Pat. No. 5,244,985 patent owned by New Japan Chemical describes the preparation of a family of epoxy polyesters, containing at least three units of substituted epoxycyclohexane, with an average numeric molecular weight lying between 1,000 and 10,000. As described in the examples of this patent, the products are liquids and for this reason are suited to UV cross-linking in liquid paints by the combination with liquid carboxylic anhydrides, as plasticising agents for PVC. Vice versa the solid samples like the samples obtained in comparative example 3 of the cited United States patent are incompatible with the 4-methyl-hexahydrophthalic anhydride and provide a coating with insufficient cross-linking. Due to their liquid characteristics, they are not suited to hardenable powder coatings, since one of the characteristics required of a powder-base paint is packing stability and this cannot be achieved by using a high percentage of a liquid component in the paint.

Document JP 7062064 owned by the aforesaid New Japan Chemical describes the same polyester epoxidates as the preceding patent and claims that they are suited to the preparation of thermal-hardening paints if combined with cross-linking catalysts such as boron trifluoride, tetrabutylammonium halide, tetraphenylphosphonium halide in the presence or otherwise of a polyester hydroxylate, for example after cross-linking for 15 minutes at 100° C. and subsequently 30 minutes at 160° C.

The purpose of this invention is to propose new solid resins that guarantee the storage stability and low toxicity necessary for the uses described above.

Solid epoxy cycloaliphatic resins free from reactive terminal groups (such as carboxylic or hydroxylic groups) are described in document PCT/EP98/01609 (publication reference No. WO98/42766) containing at least two substituted epoxycyclohexane units per molecule and a linear or branched alcohol, and the said resins are essentially free from monomeric products. Such a polymer consists of a monofunctional alcohol, epoxycyclohexane units and a glycol. On the one hand, such resins are solid and have proved to be good TGIC substitutes, but the basic polyesters must be subjected to a long vacuum distillation phase and high-temperature and considerable vacuum (examples with 13 mm Hg residual pressure) to remove all the monomeric compounds and therefore to obtain a solid resin from the synthesis of the polyester to be epoxidised.

Moreover, the polyester epoxidate obtained from the cited publication reference No. WO98/42766 is unstable up to 200° C. and this generates problems in the distillation phase of the solvent used for epoxidation and decreases the characteristics of the final paint film.

The purpose of this invention is to obtain a solid epoxidised hydroxylate polyester resin with a glass transition temperature ≧35°]C., high thermal stability, low toxicity, free from monomeric products and which can be used as a resin in hardenable powder-base coatings.

According to this invention, the resin can be obtained by using the procedure described in claim 1 and is claimed in claim 16. Further advantages of the invention are achieved through the characteristics described in the dependent claims.

In fact, surprisingly a procedure was discovered that enables epoxy resins, which are solid and suitable for use in hardenable powder-base paints to be prepared.

The precursory polyester hydroxylate of the process according to the invention includes:

i) a first carboxylic acid, or a mixture of such acids, or an anhydride, or a mixture of such anhydrides, having the following formulae:

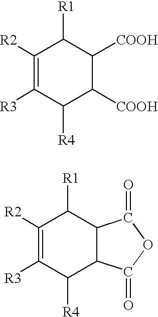

where R1, R2, R3 and R4 are chosen independently from the group comprising H and CH3;

ii) a glycol, or a mixture of glycols, of a general formula X—(OH)n, where X is a linear or branched alkyl C2-C55, a linear or branched alkanyl C2-C55, a linear or branched alkanediyl C2-C55 or a cycloaliphatic C3-C55 or aromatic radical C6-C55 and n is an integer between 2 and 4;

iii) a second different carboxylic acid, or a mixture of such acids, with the formula R—(C—OOH)n or a relative anhydride, or a mixture of such anhydrides,

where R is a linear or branched alkyl C1-C36, cycloalkane C5-C36, cycloalkene C5-C36 or aromatic C8-C36 and n is an integer between 2 and 4; and where the molar ratio between i) and iii) varies between 100/0 and 5/95, and in which the total number of hydroxylic group equivalents contained in ii) lies between 1.005 and 1.5 compared to the total number of carboxylic group equivalents of components i)+iii).

It is necessary to consider that if anhydride compounds are used an anhydride group equivalent corresponds to 2 carboxylic group equivalents.

The molecular weight of the polyester hydroxylate lies between 1,000 and 15,000, the acid number is ≦10 mg KOH/g.

The first carboxylic acid is preferably chosen from the group consisting in tetrahydrophthalic, methyl-tetrahydrophthalic, nadic, methyl-nadic acid and their anhydrides.

The preferred glycols are 2,2-dimethyl-1,3 propylene glycol, 1,2-ethylene glycol, 1,2 propylene glycol, diethylenic glycol and 1,6 hexathylene glycol. The preferred polyhydroxylic alcohols are 1,1,1-trimethylolpropane alcohol, pentaerythrite alcohol, glycerine alcohol and trihydroxyethylisocyanate alcohol.

The second carboxylic acid is preferably chosen from the group consisting in terephthalic, isophthalic, adipic, 1,4-cyclohexandicarboxylic, phthalic, maleic, fumaric, succinic, trimellitic acid and their anhydrides.

The process claimed by the invention includes therefore the following phases:

a) preparing the precursory polyester by esterifying the mixture of i), ii) and iii) at a temperature of between 100 and 250° C. in the presence or otherwise of a possible esterifying catalyst until obtaining an acid groups content ≦10 mg KOH/g, hydraulic groups content of between 15 and 200 mg KOH/g.

b) Epoxidising the precursory polyester using a peroxide compound

c) cooling the reaction mixture to room temperature, separating and drying the resin at a temperature of up to 220° C.

if the esterifying catalyst is present in phase a) it is preferably a stannous salt, for example: dibutyl or monobutyl stannous oxide.

As an option, a completion phase for the polyesterification may be executed at the end of preparatory phase a) of the precursory polyester by applying a slight vacuum (0.05-0.5 bar) after having distilled at atmospheric pressure. This optional phase consists in eliminating the residual water molecules and may be executed using any method known in the prior art and preferably by distillation under a slight vacuum until obtaining an acid groups content ≦10 mg KOH/g, hydroxylic groups content of between 15 and 200 mg KOH/g. Following the water removal phase the average numeric molecular weight lies between 1,000 and 10,000 and a solid polyester is obtained with Tg≧20° C.

The epoxidation phase b) of the polyester hydroxylate may be achieved by reacting the unsaturated product obtained from phase a) with a peroxide compound. Either organic or inorganic peroxides can be used as suitable peroxide compounds. Peroxycarboxylic acids such as peroxide compounds are used preferably, since monoperphthalic acid is especially preferred. Hydrogen peroxide was also found to be a preferred compound. When hydrogen peroxide is used a phase transfer catalyst can be adopted. Examples of phase transfer catalysts are described in the document J. polym. Sci., Part A: Polymz. Chem. 1993, 31 1825-1938.

The epoxidation reaction is advantageously executed in an inert solvent. Suitable inert solvents are, for example, alkyl esters, halogenated hydrocarbons, cycloaliphatic hydrocarbons, aromatic or alcohol hydrocarbons.

After having cooled the mixture in phase c), the resin may be optionally washed with an aqueous solution, the two phases obtained can be separated using techniques known to the prior art and the solvent can be distilled from the resin under vacuum up to 220° C., at the end of which a solid resin is obtained. After the said cooling of phase c) to room temperature is completed the reaction mixture is, then preferably neutralised using an aqueous solution of NaHCO3. The organic layer is then separated either in a reactor or by using a separation column and the remaining organic layer is dried under vacuum at a temperature of up to 220° C. without there being a change in the characteristics of the epoxidised hydroxylate polyester.

The hardenable powder resin obtained in this way is used as a binder in compositions for powder-base paints and is added to different compounds for this purpose. Therefore, this invention also refers to a composition as described in claim 19.

Powder-base paint usually includes a part of hardenable binder and additional ingredients such as catalysts, pigments, fillers and additives. The hardenable binder portion may comprise the epoxidised cycloaliphatic hydroxylate polyester and a catalyst.

When the epoxidised cycloaliphatic hydroxylate resin is used as a single binder the composition can incorporate cationic photo-initiators such as triarylsulphonium-hexafluorophosphate salts with a ratio between the epoxidic resin and the photo-initiator that varies between 20 to 1 and 99 to 1.

Surprisingly, it was found that it is possible to obtain paints that are resistant to outdoor conditions, matt (brilliance at 60°≦40 gloss), semi-matt, semi-gloss by using the epoxy cycloaliphatic hydroxylate resin as the unique binder combined with a dicyandiamide, amidine or cycloamidine and relative salts (defined as the family of dicyandiamides) in a ratio between the epoxy resin and the dicyandiamide family that varies between 20 to 1 and 99 to 1.

The binding portion of the coating in addition to being mono-component can have two components and in this case the composition also incorporates a component capable of cross-linking with the epoxy resin, as for example: polymers containing carboxylic groups, anhydride groups or epoxidic groups, in addition to the epoxidic cycloaliphatic hydroxylate resin.

For example: the carboxylate polymer can be selected from a group consisting in:

a carboxylate polyester having Tg≧35° C. or a melting point (MP)≧100° C., and an Acidity Number (AN) between 10 and 100 mg KOH/g and a Viscosity (Vx)≧1000 mPa.s at 200° C., where the ratio between the epoxidic equivalents and the carboxylic equivalents varies between 1.8 to 1 and 0.6 to 1,

an acrylic carboxylate resin with Tg≧35° C. or MP≧100° C., an AN between 10 and 100 mg KOH/g and Vx≧500 mPa.s at 175° C., where the ratio between the epoxidic equivalents and the carboxylic equivalents varies between 1.8 to 1 and 0.6 to 1,

an aliphatic, aromatic or cycloaliphatic polyanhydride or a polycarboxylic acid with Tg≧45° C. or an MP≧100° C. with a partial AN between 200 and 350 mg KOH/g and where the ratio between the epoxidic and anhydride equivalents varies between 0.6 to 1 and 3 to 1.

Other examples of components usable in combination with the solid epoxidic hydroxylate polyesters are represented by:

a mixture of polyanhydrides (as indicated above) and hydroxylate polyesters with Tg≧45° C. or a MP≧100° C. and a Hydroxyl Number (OHN) between 10 and 300 mg KOH/g and a Viscosity (Vx)≧1000 mPa.s at 200° C., where the ratio between the epoxidic, anhydride and hydroxyl equivalents varies between 3-0.6 to 1;

a mixture of isocyanates locked carboxylates with Tg≧35° C. or a MP≧90° C., an AN between 5 and 100 mg KOH/g, locked isocyanate content between 3 and 20%, and where the ratio between the carboxylic, isocyanate and epoxidic equivalents varies between 0.01-1 to 3;

a mixture of carboxylic polymers and mixtures of other compounds capable of cross-linking with carboxylate resins selected from the group consisting in β-hydroxy-alkylamides, Araldite PT 910 (Ciba), Nissan MT 239 (Nissan), acrylic polymers with glycidyl functionalities, epoxidic resins derived from bisphenol A, etc.

Surprisingly, it was again found that it was possible to obtain matt paints resistant to outdoor conditions, (brilliance at 60°≦40 gloss), semi-matt, semi-gloss by using the epoxidic cycloaliphatic hydroxylate resin in combination with carboxylate resins as for example: carboxylate, acrylic carboxylate, polyanhydride polyesters, and an amidine salt such as Vestagon B® 68 (the salt of a polycarboxylic acid and a cyclic amidine) in a ratio between the epoxidic equivalents and, carboxylic equivalents that varies between 2 to 1 and 0.8 to 1 and the weight ratio between the epoxidic resin and the compound of the dicyandiamide family varies between 30 to 1 and 99 to 1.

The reactive polymers are preferably carboxylate polyesters with an acidity number of 10-100 mg KOH/g and a Tg≧35° C. This type of polyester is characterised by the fact of reacting in the presence of a catalyst, as for example, metal soaps, ammonia salts, tertiary and secondary amines, phosphonium and imidazole salts.

The powder-base paint compositions can be prepared using methods known to the prior art, for example by mixing and extruding the components in a heated extruder and subsequently mixing the solidified extruded material reducing the material into particles with dimensions suitable for normal application techniques.

The powder-base paints obtained in this way can be applied to the supports to be painted in accordance with normal powder application techniques, as for example by using the electrostatic tribo or crown or the fluid bed application technique. In the case of an application where wood is the support, it is possible, for example, to apply a conducting paint or spray the paint melt using thermal spray guns (heated spray guns) before the electrostatic application.

In general, these paints are suitable both for cold and hot applications; in the case of large size supports, as for example, metal or wooden laminas or paper panels, painting in a vertical position is also possible, without the powder becoming detached from the painted piece before cross-linking phase.

With these procedures in given circumstances it is possible to forgo the electrostatic application.

The paints obtained using this patent can be used to paint all supports, as for example: wood, glass, metal, paper and plastic.

The invention will now be described based on a number of non-limiting examples of the invention.

### Comparative Polyester 0

### Polyester from 1,2,3,6-Tetrahydrophthalic-Anhydride, Trimethylolpropane and Isobutyl Alcohol

A glass reactor was charged with 1,369 g (9 moles) of 1,2,3,6, Tetrahydrophthalic Anhydride (THPA), 404.5 g (3 moles) of Trimethylolpropane, 699 g (9.4 moles) of Isobutyl Alcohol and 35 g of Xylene. The mixture was heated and the temperature was gradually increased up to 230° C. The esterification reaction was performed by distilling the reaction water formed until the acidity number of the mixture reached 18 mg KOH/g. 1.2 g of stannous oxide were then added. The Xylene and 589 g of Diisobutyltetrahydrophthalate were distilled under vacuum at 230° C., after 24 hours, while gradually reducing the pressure from 1,000 to 13 mbar. The reaction mixture was filtered and 1,677 g of polyester were obtained:

| | |
|---|---|
| Iodine Number: | 101.5 |
| Acidity Number: | 2 mg KOH/g. |
| Viscosity at 100° C.: | 2,260 mPa · s. |
| Mw | 2,050 |
| Hydroxyl Number: | 2.1 mg KOH/g |

### Comparative Epoxide 1

### Epoxidation of the Polyester Obtained in Comparative Example 0

The polyester obtained from 1,2,3,6-Tetrahydrophthalic Anhydride, Trimethylolpropane and Isobutyl Alcohol in comparative example 0 (250 g, 1 equiv.) was dissolved in 625 g of Xylene with 2.5 g of Methyl-trioctylammonium Chloride at 40° C.

288 g of an aqueous solution containing hydrogen peroxide (1.35 moles), sodium tungstate (0.05 moles) and phosphoric acid (0.15 moles) were rapidly added to the mixture. The temperature of the reaction mixture, continuously mixed, was maintained at 40° C. by immersing the reactor in cold water. The reactor was immersed in a hot bath when the exothermic reaction had ended and the reaction mixture was maintained at 40° C. for 4 hours. The reaction mixture was filtered after cooling to room temperature and the solid was washed with sodium carbonate solution and then with water. The organic layer was concentrated under vacuum and dried at 80° C.-10 Torr (13 mbar) to produce 268 g of epoxidic resin:

| | |
|---|---|
| Oxyranic Content: | 4.8% |
| Iodine Number: | 2.5 |
| Acidity Number: | 0 mg KOH/g |
| Viscosity at 100° C.: | 13,400 mPa sec. |
| Mw: | 2,700 |

### Comparative Epoxide 2

### Epoxidation of the Polyester Obtained in Comparative Example 0

The polyester obtained from 1,2,3,6-Tetrahydrophthalic Anhydride, Trimethylolpropane and Isobutyl Alcohol in comparative example 0 (250 g, 1 equiv.) was dissolved in 625 g of Xylene with 2.5 g of methyl-trioctylammonium chloride at 40° C.

288 g of an aqueous solution containing hydrogen peroxide (1.35 moles), sodium tungstate (0.05 moles) and phosphoric acid (0.15 moles) were rapidly added to the mixture. The temperature of the reaction mixture, continuously mixed, was maintained at 40° C. by immersing the reactor in cold water. The reactor was immersed in a hot bath when the exothermic reaction had ended and the reaction mixture was maintained at 40° C. for 4 hours. The reaction mixture was filtered and the solid washed with a sodium carbonate solution and then with water after cooling to room temperature. The organic layer was concentrated under vacuum and dried at 220° C.-10 Torr (13 mbar), but at the end of distillation, gelification of the epoxidic resin occurred inside the reactor, which rendered the product unusable in the preparation of powder-base paints.

### Polyester 3 According to the Invention

### Polyester from 1,2,3,6 Tetrahydrophthalic Anhydride and Neopentylglycol.

A reactor was charged with 1520 g (10 moles) of 1,2,3,6, Tetrahydrophthalic Anhydride (THPA), 1,145 g (11 moles) of Neopentylglycol and 2.8 g of Monobutylstannoic Acid. The mixture was heated and the temperature was gradually increased to 240° C. The esterification reaction was performed by distilling the water formed until the Acidity Number of the mixture reached 3 mg KOH/g.

The reaction mixture was filtered and 2450 g of polyester were obtained:

| | |
|---|---|
| Iodine Number: | 104 |
| Acidity Number: | 2.5 mg KOH/g. |
| Viscosity at 200° C.: | 160 mPa · s. |
| Mw: | 2,500 |
| Hydroxyl Number: | 38.1 mg KOH/g |
| Tg: | 20.5° C. |

### Epoxide A According to the Invention

### Epoxidation of the Polyester Obtained in Example 3 According to the Invention.

The polyester obtained from 1,2,3,6 Tetrahydrophthalic Anhydride, and Neopentylglycol in example 3 according to the invention (250 g, 1 equiv.) was dissolved in 450 g of Ethyl Acetate at 50° C.

Solid Monoperphthalic Acid (95% purity, 249 g, 1.3 moles) was added in portions over a period of 1 hr. The reaction mixture, continuously mixed, was maintained at 50° C. by immersing the reactor in cold water. The reactor was immersed in hot water and the reaction mixture was maintained at 50° C. for a further 2 hrs. when the exothermic reaction had ended. The reaction mixture was filtered and the solid was washed with an aqueous solution of sodium carbonate and then with water after cooling to room temperature. The organic layer was concentrated under vacuum and dried from room temperature up to 220° C.-10 Torr (13 mbar) to produce 268 g of epoxidic resin:

| | |
|---|---|
| Oxyranic Content: | 5.5% |
| Iodine Number: | 1.3 |
| Acidity Number: | 0.5 mg KOH/g |
| Viscosity at 200° C.: | 105 mPa · s. |
| Mw: | 2,600 |
| Hydroxyl Number: | 37.4 mg KOH/g |
| Tg: | 40° C. |

### Polyester 4 According to the Invention

### Polyester Obtained from 1,2,3,6 Tetrahydrophthalic Anhydride, Trimethylolpropane and Ethylene Glycol.

A reactor was charged with 1,520 g (10 moles) of 1,2,3,6 Tetrahydrophthalic Anhydride (THPA), 20 g (0.15 moles) of Trimethylolpropane, 670 g (10.80 moles) of Ethylene Glycol and 2.8 g of Monobutylstannoic Acid. The mixture was heated and the temperature was gradually raised to 240° C. The esterification reaction was performed by distilling the water formed until the Acidity Number of the mixture reached 3 mg KOH/g.

The reaction mixture was filtered and 2,000 g of polyester were obtained:

| | |
|---|---|
| Iodine Number: | 127 |
| Acidity Number: | 2.9 mg KOH/g. |
| Viscosity at 200° C.: | 100 mPa · s. |
| Mw: | 2,100 |
| Hydroxyl Number: | 47 mg KOH/g |
| Tg: | 21° C. |

### Polyester 5 According to the Invention.

### Polyester Obtained from 1,2,3,6 Tetrahydrophthalic Anhydride, Terephthalic Acid and Neopentylglycol.

A reactor was charged with 760 g (5 moles) of 1,2,3,6 Tetrahydrophthalic Anhydride (THPA), 813 g (4.9 moles) of Terephthalic Acid and 1,145 g (11 moles) of Neopentylglycol and 2.8 g Monobutylstannoic Acid. The mixture was heated and the temperature was gradually raised to 240° C. The esterification reaction was performed by distilling the water formed until the Acidity Number of the mixture was ≦15 mg KOH/g.

When subjected to a slight vacuum the reaction mixture then reached an Acidity Number ≦5 mg KOH/g.

The reaction mixture was filtered and 2,450 g of polyester were obtained:

| | |
|---|---|
| Iodine Number: | 65 |
| Acidity Number: | 1.6 mg KOH/g. |
| Viscosity at 200° C.: | 3,680 mPa · s. |
| Hydroxyl Number: | 25.6 mg KOH/g |
| Tg: | 29° C. |

### Polyester 6 According to the Invention.

### Polyester Obtained from 1,2,3,6 Tetrahydrophthalic Anhydride, Isophthalic Acid and Neopentylglycol.

A reactor was charged with 950 g (6.25 moles) of 1,2,3,6 Tetrahydrophthalic Anhydride (THPA), 1,038 g (6.25 moles) of Isophthalic Acid and 1.430 g (13.75 moles) of Neopentylglycol and 3 g of Monobutylstannoic Acid. The mixture was heated and the temperature was gradually raised to 240° C. The esterification reaction was performed by distilling the water formed until the Acidity Number of the mixture reached ≦15 mg KOH/g.

When subjected to a slight vacuum the reaction mixture then reached an Acidity Number ≦3 mg KOH/g.

The reaction mixture was filtered and 3,050 g of polyester were obtained:

| | |
|---|---|
| Iodine Number: | 52 |
| Acidity Number: | 2.8 mg KOH/g. |
| Viscosity at 200° C.: | 280 mPa · s. |
| Mw: | 3,200 |
| Hydroxyl Number: | 38 mg KOH/g |
| Tg: | 32° C. |

### Polyester 7 According to the Invention.

### Polyester Obtained from 1,2,3,6 Tetrahydrophthalic Anhydride, Isophthalic Acid and Propylene Glycol.

A reactor was charged with 1,026 g (6.75 moles) of 1,2,3,6 Tetrahydrophthalic Anhydride (THPA), 1,120 g (6.75 moles) of Isophthalic Acid and 1,129 g (14.9 moles) of Propylene Glycol and 3 g of Monobutylstannoic Acid. The mixture was heated and the temperature was gradually raised to 240° C. The esterification reaction was performed by distilling the water formed until the Acidity Number of the mixture reached <20 mg KOH/g.

When subjected to a slight vacuum the reaction mixture then reached an Acidity Number ≦5 mg KOH/g.

The reaction mixture was filtered and 2,900 g of polyester were obtained:

| | |
|---|---|
| Iodine Number: | 59 |
| Acidity Number: | 4.4 mg KOH/g. |
| Viscosity at 200° C.: | 1,360 mPa · s. |
| Hydroxyl Number: | 17.3 mg KOH/g |
| Tg: | 44° C. |

### Polyester 8 According to the Invention

### Polyester Obtained from 1,2,3,6 Tetrahydrophthalic Anhydride, Terephthalic Acid and Neopentylglycol.

A reactor was charged with 152 g (1 mole) of 1,2,3,6 Tetrahydrophthalic Anhydride (THPA), 1,477 g (8.9 moles) of Terephthalic Acid and 1,145 g (11 moles) of Neopentylglycol and 2.8 g of Monobutylstannoic acid. The mixture was heated and the temperature was gradually raised to 240° C. The esterification reaction was performed by distilling the water formed until the Acidity Number of the mixture was ≦15 mg KOH/g.

When subjected to a slight vacuum the reaction mixture then reached an Acidity Number ≦5 mg KOH/g. The reaction mixture was filtered and 2,420 g of polyester were obtained:

| | |
|---|---|
| Iodine Number: | 13 |
| Acidity Number: | 3.0 mg KOH/g |
| Viscosity at 200° C.: | 3,680 mPa · s |
| Hydroxyl Number: | 28 mg KOH/g |
| Tg: | 50° C. |

Following the same procedures as detailed for epoxide A

Epoxide A was obtained from polyester 3

Epoxide B was obtained from polyester 4

| | |
|---|---|
| EP: Iodine Number: | 14.9 |
| Acidity Number: | 0 mg KOH/g |
| Viscosity at 200° C.: | 255 mPa · s |
| Oxyranic content: | 5.9% |
| Hydroxyl Number: | 45 mg KOH/g |
| Tg: | 35.5° C. |

Epoxide C was obtained from polyester 5

| | |
|---|---|
| EP: Iodine Number: | 0.03 |
| Acidity Number: | 0 mg KOH/g |
| Viscosity at 200° C.: | 1,780 mPa · s |
| Oxyranic content: | 2.8% |
| Hydroxyl Number: | 26.5 mg KOH/g |
| Tg: | 44° C. |

Epoxide D was obtained from polyester 6

| | |
|---|---|
| EP: Iodine Number: | 9.7 |
| Acidity Number: | 3.5 mg KOH/g |
| Viscosity at 200° C.: | 560 mPa · s |
| Mw: | 3,388 |
| Oxyranic content: | 2.55% |
| Tg: | 36° C. |

Epoxide E was obtained from polyester 7

| | |
|---|---|
| EP: Iodine Number: | 11.7 |
| Acidity Number: | 3 mg KOH/g |
| Viscosity at 200° C.: | n.d. |
| Oxyranic content: | 2.56% |
| Tg: | 59° C. |

Epoxide F was obtained from polyester 8

| | |
|---|---|
| EP: Iodine Number: | 1.2 |
| Acidity Number: | 1.8 mg KOH/g |
| Viscosity at 200° C.: | 2,600 mPa · s |
| Oxyranic Content: | 0.7% |
| Tg: | 53° C. |

The table below details the compounds obtained:

| Polyester | Epoxide obtained |
|---|---|
| Comparative polyester 0 | Comparative epoxide 1 |
| Comparative polyester 0 | Comparative epoxide 2 |
| Polyester 3 according to the invention | Epoxide A |
| Polyester 4 according to the invention | Epoxide B |
| Polyester 5 according to the invention | Epoxide C |
| Polyester 6 according to the invention | Epoxide D |
| Polyester 7 according to the invention | Epoxide E |
| Polyester 8 according to the invention | Epoxide F |

### Preparation of the Powder-Base Paints and Application Thereof

A series of powder-base paints were prepared and applied using the following compositions for the powder-base paints where the parts are referred to parts by weight.

REFERENCE TEST 1

| | |
|---|---|
| Alftalat AN 989 ® | 569 |
| Araldite PT 810 ® (TGIC Ciba) | 43 |
| Additol XL 496 ® | 30 |
| Irganox 1010 ® (Ciba) | 3 |
| Benzoin | 5 |
| Kronos 2160 ® (NL Chemical) | 350 |
| | 1,000 |

REFERENCE TEST 2

| | |
|---|---|
| Alftalat AN 745 ® | 492 |
| EPOXIDE A | 123 |
| Additol XL 496 ® | 30 |
| Tetrabutylammonium bromide | 20 |
| Benzoin | 5 |
| Kronos 2160 ® (NL Chemical) | 330 |
| | 1,000 |

REFERENCE TEST 3

| | |
|---|---|
| Alftalat AN 770 ® | 498 |
| Comparative EPOXIDE 1 | 122 |
| Additol XL 496 ® | 30 |
| Benzoin | 5 |
| Kronos 2160 ® (NL Chemical) | 345 |
| | 1,000 |

TEST 1

| | |
|---|---|
| Alftalat AN 770 ® | 504 |
| EPOXIDE A | 116 |
| Additol XL 496 ® | 30 |
| Benzoin | 5 |
| Kronos 2160 ® (NL Chemical) | 345 |
| | 1,000 |

TEST 2

| | |
|---|---|
| Alftalat AN 720 ® | 285 |
| EPOXIDE A | 285 |
| Additol XL 496 ® | 30 |
| Benzoin | 5 |
| Blanc Fixe ABR (SACHTLEBEN) | 105 |
| Kronos 2160 ® (NL Chemical) | 290 |
| | 1,000 |

TEST 3

| | |
|---|---|
| Alftalat VAN 9830 ® | 285 |
| EPOXIDE A | 285 |
| Additol XL 496 ® | 30 |
| Benzoin | 5 |
| Blanc Fixe ABR (SACHTLEBEN) | 105 |
| Kronos 2160 ® (NL Chemical) | 290 |
| | 1,000 |

TEST 4

| | |
|---|---|
| Alftalat VAN 9932 ® | 285 |
| EPOXIDE A | 285 |
| Additol XL 496 ® | 30 |
| Benzoin | 5 |
| Blanc Fixe ABR (SACHTLEBEN) | 105 |
| Kronos 2160 ® (NL Chemical) | 290 |
| | 1,000 |

TEST 5

| | |
|---|---|
| Alftalat AN 721 ® | 285 |
| EPOXIDE A | 315 |
| Additol XL 496 ® | 30 |
| Benzoin | 5 |
| Vestagon B 68 (Degussa) | 20 |
| Additol 03866/15 | 7 |
| Kronos 2160 ® (NL Chemical) | 338 |
| | 1,000 |

TEST 6

| | |
|---|---|
| EPOXIDE A | 615 |
| Additol XL 496 ® | 30 |
| Benzoin | 5 |
| Additol 03866/15 | 7 |
| Kronos 2160 ® (NL Chemical) | 343 |
| | 1,000 |

TEST 7

| | |
|---|---|
| EPOXIDE C | 529 |
| Additol VXL 1381 | 86 |
| Additol XL 496 ® | 30 |
| Benzoin | 5 |
| Additol 03866/15 | 7 |
| Kronos 2160 ® (NL Chemical) | 343 |
| | 1,000 |

TEST 8

| | |
|---|---|
| EPOXIDE C | 523 |
| Additol VXL 9946 ® | 92 |
| Additol XL 496 ® | 30 |
| Benzoin | 5 |
| Kronos 2160 ® (NL Chemical) | 343 |
| | 1,000 |

TEST 9

| | |
|---|---|
| EPOXIDE C | 492 |
| Beckopox EH 694 ® | 123 |
| Additol XL 496 ® | 30 |
| Benzoin | 5 |
| Additol 03866/15 | 7 |
| Kronos 2160 ® (NL Chemical) | 343 |
| | 1,000 |

TEST 10

| | |
|---|---|
| EPOXIDE C | 888 |
| Mixture of triarylsulphonium hexafluoride antimonate salts | 37 |
| Additol XL 449 ® | 70 |
| Benzoin | 5 |
| | 1,000 |

TEST 11

| | |
|---|---|
| EPOXIDE C | 358 |
| Lithium acid trifluoromethansulphonic salt | 8 |
| Additol XL 496 ® | 50 |
| Benzoin | 8 |
| Kronos 2160 ® (NL Chemical) | 576 |
| | 1,000 |

TEST 12

| | |
|---|---|
| EPOXIDE B | 590 |
| Polyamidoamine | 25 |
| Additol XL 496 ® | 30 |
| Benzoin | 5 |
| Kronos 2160 ® (NL Chemical) | 350 |
| | 1,000 |

TEST 13

| | |
|---|---|
| EPOXIDE C | 590 |
| Dicyandiamide | 25 |
| Additol XL 496 ® | 30 |
| Benzoin | 5 |
| Kronos 2160 ® (NL Chemical) | 350 |
| | 1,000 |

TEST 14

| | |
|---|---|
| Alftalat AN 745 ® | 280 |
| EPOXIDE B | 252 |
| Additol VXL 1381 | 83 |
| Additol XL 496 ® | 30 |
| Additol 03866/15 | 7 |
| Benzoin | 5 |
| Kronos 2160 ® (NL Chemical) | 343 |
| | 1,000 |

TEST 15

| | |
|---|---|
| EPOXIDE C | 117,5 |
| Alftalat VAN 9952 | 485 |
| Araldite PT 910 | 17,5 |
| Additol VXL 9824 ® | 30 |
| Benzoin | 5 |
| Kronos 2160 ® (NL Chemical) | 345 |
| | 1,000 |

TEST 16

| | |
|---|---|
| EPOXIDE C | 115 |
| Alftalat 03807 | 475 |
| Primid XL 552 | 10 |
| Additol VXL 9824 ® | 50 |
| Benzoin | 3 |
| Kronos 2160 ® (NL Chemical) | 347 |
| | 1,000 |

TEST 17

| | |
|---|---|
| Alftalat 03854 | 451 |
| EPOXIDE C | 194 |
| Benzoin | 5 |
| Kronos 2160 ® (NL Chemical) | 350 |
| | 1,000 |

TEST 18

| | |
|---|---|
| EPOXIDE C | 558 |
| Vestagon B 68 (Degussa) | 50 |
| Additol XL 496 ® | 30 |
| Benzoin | 5 |
| Additol 03866/15 | 7 |
| Kronos 2160 ® (NL Chemical) | 350 |
| | 1,000 |

Alftalat, Additol and Beckopox are registered trademarks of Solutia and correspond, respectively to:

Alftalat AN 745 is a hydroxylate polyester,

Alftalat AN 989, AN 770, AN 720, VAN 9830, VAN 9932, AN 721, VAN 9952, 03807, 03854 are carboxylate polyesters,

Additol XL 496, VXL 9824 and XL 449 are masterbatches of a stress relieving agent on an-hydroxylate polyester support,

Additol 03866/15 is a catalyst masterbatch on a carboxylate polyester support,

Additol VXL 1381 is a polyanhydride,

Additol VXL 9946 is a locked isocyanate containing carboxylic groups,

Beckopox EH 694 is polyanhydride.

Araldite PT 810 and PT 910 are trademarks registered by Ciba and correspond to epoxidic resins,

Irganox 1010 is a trademark registered by Ciba and corresponds to a phenolic type antioxidant,

Kronos 2160 is a trademark registered by NL Chemical and corresponds to a form of titanium dioxide,

Blanc Fixe ABR is a trademark registered by Sachtleben and corresponds to a form of barium sulphate,

Primid XL 552 is a trademark registered by EMS Chemie and corresponds to a β-hydroxy-alkyl-amide.

Vestagon B 68 is a trademark registered by Degussa and corresponds to a polycarboxylic acid salt and a cyclic amidine.

The powder-base paints of the above-mentioned compositions were extruded at the following conditions:

Twin-screw extruder.

Temperatures (° C.): 80-100-100 (3 heating elements) Feed ratio (8): 30

Rotation speed (rpm): 300

The powder-base paints were applied using crown effect spray guns on steel panels and cross-linking occurred in convection ovens at 200° C.×20′ with the exception of reference test 2 which was cross-linked at 220° C.×20′ and test 10 was cross-linked inside a UV lamp oven with two passes at a rate of 5 meters/minute, after melting inside an IR lamp oven. The following results were obtained:

| | Brilliance | Mechanical | Packing |
|---|---|---|---|
| | (gloss a 60°) | characteristics⁽²⁾ | stability⁽*⁾ |
| Reference test 1 | 93 | 2 | 2 |
| Reference test 2 | 90 | 5 | 3 |
| Reference test 3 | 70 | 3 | 5 |
| Test 1 | 86 | 1 | 2 |
| Test 2 | 88 | 3 | 3 |
| Test 3 | 90 | 3 | 3 |
| Test 4 | 89 | 3 | 3 |
| Test 5 | 51 | 1 | 2 |
| Test 6 | 80 | 4 | 4 |
| Test 7 | 45 | 4 | 2 |
| Test 8 | 79 | 3 | 2 |
| Test 9 | 36 | 3 | 3 |
| Test 10 | 90 | 2 | 3 |
| Test 11 | 68 | 5 | 2 |
| Test 12 | 78 | 3 | 2 |
| Test 13 | 56 | 3 | 2 |
| Test 14 | 82 | 3 | 3 |
| Test 15 | 91 | 2 | 2 |
| Test 16 | 91 | 1 | 2 |
| Test 17 | 88 | 1 | 2 |
| Test 18 | 10 | 2 | 2 |

Grading 1: excellent, 2: good, 3: adequate, 4: poor, 5: negative.
⁽²⁾determined visually.
⁽*⁾The powder-base paint stocked for 30 days at 40° C. was graded for the degree of spacing and ease of breaking up possible lumps that had formed: a lower number corresponds to a better grading.

The hardenable powder-base resins described in this report are not only solid, but surprisingly, on their own, or also combined with hydroxylate polyesters and the catalysts described in the document in JP 7062064, although containing hydroxylic groups and epoxidic cycloaliphatic groups do not cross-link nor do they gelatinise even at temperatures of 200° C. and this aspect is fundamental in the synthesis of the compound object of this invention, since it enables synthesis phases to be performed, as for example: vacuum distillation of the epoxidised hydroxylate polyester, for several hours at temperatures of up to 220° C., without the risk of gelation.

In fact, temperatures of 220° C. were reached in the preparation of Epoxide A without epoxide gelation and in reference test 2 entirely negative mechanical characteristics were obtained.

According to the patent a net improvement in the mechanical characteristics is obtained by substituting comparative Epoxide 1 with Epoxide A, as shown in the comparison between reference test 3 and test 1 in which the Epoxide is the only component that changes.

The overall characteristics of the paint are comparable with the characteristics achievable using traditional paints, compare reference test 1 and test 17.

It is possible to obtain low brilliance values as preferred by using amidine salts, combined with good technical characteristics and packing stability as indicated in test 18.

1. A process to prepare solid epoxidic cycloaliphatic hydroxylate resins with Tg≧35° C., epoxidic equivalent weight between 190 and 3000, Hydroxyl Number between 15 and 200 mg KOH/g, numeric molecular weight between 800 and 15,000 and preferably between 1,000 and 10,000, comprising the following phases:
a) prepare the precursory polyester by esterifying the following mixture at a temperature of between 100 and 250° C., in the presence or otherwise of a possible esterification catalyst until obtaining an acid groups content ≦10 mg KOH/g, hydroxylate groups content between 15 and 200 mg KOH/g:
i) a first carboxylic acid, or a mixture of such acids, or an anhydride, or a mixture of such anhydrides, having the following formulae: 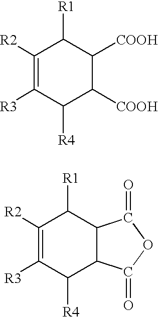
where R1, R2, R3 and R4 are chosen independently from the group comprising H and CH3;
ii) a glycol, or a mixture of glycols, having the following general formula
X—(OH)n, where X is a linear or branched alkyl C2-C55, a linear or branched alkanyl C2-C55, a linear or branched alkanediyl C2-C55 or a cycloaliphatic C3-C55 or aromatic C6-C6-C55 radical and n is an integer between 2 and 4;
iii) a second different carboxylic acid, or mixture of such acids, having the formula
R—(C—OOH)n or a relative anhydride, or a mixture of such anhydrides,
where R is a linear or branched alkyl C1-C36, cycloalkane C5-C36, cycloalkene C5-C36 or aromatic C8-C36 and n is an integer between 2 and 4;
and where the molar ratio between i) and iii) varies between 100/0 and 5/95, and in which the total number of hydroxylic group equivalents contained in ii) lies between 1.005 and 1.5 compared to the total number of carboxylic group equivalents of components i)+iii);
b) epoxidise the precursory polyester using a peroxide compound, and
c) cool the reaction mixture to room temperature, separate and dry the resin at a temperature of up to 220° C.

2. The process, according to claim 1 wherein a completion phase of the polyesterification process is performed between the preparation phase a) of the precursory polyester and the esterification phase b) by applying a mild vacuum (0.05-0.5 bar) after having distilled at atmospheric pressure.

3. The process, according to claim 2 wherein the polyesterification completion phase consists in eliminating water molecules by distilling under a moderate vacuum until obtaining an acidity number ≦10 mg KOH/g, a hydroxyl number of between 15 and 200 mg KOH/g.

4. The process, according to claim 1 or 2, wherein the resin is washed with an aqueous solution after having cooled the mixture in phase c), the two phases obtained are separated using techniques known to the prior art and the solvent is distilled from the resin under vacuum at a temperature of up to 220° C., at the end of which a solid resin is obtained.

5. The process, according to any of claims 1-3 wherein the first carboxylic acid or carboxylic anhydride is chosen from the group consisting in tetrahydrophthalic acid, methyl-tetrahydrophthalic, nadic, methyl-nadic and their anhydrides.

6. The process, according to any of the preceding claims wherein the glycols are chosen from the group consisting in 2,2-dimethyl-1,3 propylene glycol, 1,2-ethylene glycol, 1,2 propane glycol, diethylenic glycol and 1,6 hexathylene glycol.

7. The process, according to any of the preceding claims wherein the polyhydroxylic alcohols are chosen from the group consisting in 1,1,1-trimethylolpropane alcohol, pentaerythritol alcohol, glycerine alcohol and trihydroxyethylisocyanate alcohol.

8. The process, according to any of the preceding claims wherein the second carboxylic acid is chosen from the group consisting in terephthalic, isophthalic, adipic, 1,4-cyclohexandicarboxylic, phthalic, maleic, fumaric, succinic, trimellytic acid and their anhydrides.

9. The process, according to any of the wherein claims wherein phase b) of the polyester epoxidation process is performed by reacting the unsaturated product of phase c) with a peroxide compound.

10. The process, according to claim 8 wherein the peroxide compound is chosen from the group consisting in peroxycarboxylic acid and hydrogen peroxide.

11. The process, according to claim 9 wherein the peroxycarboxylic acid is monoperphthalic acid.

12. The process, according to any of the claims 9-11 wherein a phase transfer catalyst is added.

13. The process, according to any of the preceding claims wherein the epoxidation reaction of phase b) is performed in an inert solvent.

14. The process, according to claim 13 preceding the inert solvent is chosen from the group consisting in alkyl esters, halogenated hydrocarbons, cycloaliphatic hydrocarbons, aromatic hydrocarbons and alcohols.

15. The process, according to any of the preceding claims wherein the reaction mixture of phase c) is neutralised using an aqueous solution of NaHCO3.

16. An epoxidic cycloaliphatic hydroxylate resin obtainable by means of the procedure according to any of claims from 1 to 15.

17. An epoxidic cycloaliphatic hydroxylate resin according to claim 16 in which the epoxidic equivalent weight lies between 250 and 2,000.

18. An epoxidic cycloaliphatic hydroxylate resin according to claim 16 or 17 in which the numeric molecular weight is between 1,000 and 10,000.

19. A composition of hardenable powder-base paint containing a) a solid epoxidic cycloaliphatic hydroxylate resin according to any of claims 16-18 and b) a component capable of co-cross-linking with and/or a cross-linking catalyst for the solid epoxidic cycloaliphatic hydroxylate resin.

20. A composition according to claim 19 in which b) is chosen from:
i) a carboxylate polymer chosen from the group consisting in:
a carboxylic polyester with Tg≧35° C. or a melting point (MP) ≧100° C., and Acidity Number (AN) between 10 and 100 mg KOH/g and a Viscosity (Vx) ≧1000 mPa.s at 200° C., where the ratio between the epoxidic equivalents and the carboxylic equivalents varies between 1.8 to 1 and 0.6 to 1,
an acrylic carboxylate resin with Tg≧35° C. or MP ≧100° C., AN between 10 and 100 mg KOH/g and Vx≧500 mpa.s at 175° C., where the ratio between the epoxidic equivalents and the carboxylic equivalents varies between 1.8 to 1 and 0.6 to 1,
an aliphatic, aromatic or cycloaliphatic polyanhydride or a polycarboxylic acid with Tg≧45° C. or a MP ≧100° C. with a partial AN between 200 and 350 mg KOH/g and where the ratio between the epoxidic and anhydride equivalents varies between 0.6 to 1 and 3 to 1;
ii) a cation photo-initiator of the triarilsulphonium-hexafluorophosphate type salts where the ratio between the epoxidic resin and the photo-initiator varies between 20 to 1 and 99 to 1;
iii) a dicyandiamide, amidine or cycloamidine and relative salts (defined as a dicyandiamide family) where the ratio between the epoxidic resin and the dicyandiamide family varies between 20 to 1 and 99 to 1;
iv) a mixture of polyanhydrides (as described above) and hydroxylate polyesters with Tg≧45° C. or a MP ≧100° C. a Hydroxyl Number (OHN) between 10 and 300 mg KOH/g and a Viscosity (Vx) ≧1000 mPa.s at 200° C., where the ratio between the epoxidic, anhydride and hydroxylic equivalents varies between 3-0.6 to 1;
v) a mixture of isocyanates locked carboxylates with Tg≧35° C. or a MP ≧90° C., an AN between 5 and 100 mg KOH/g, locked isocyanate content between 3 and 20%, and where the ratio between the carboxylic, isocyanic and epoxidic equivalents varies between 0.01-1 to 3;
vi) a mixture of carboxylic polymers and mixtures of other compounds capable of cross-linking with carboxylate resins chosen from the group consisting in β-hydroxy-alkylamides, Araldite PT 910 (Ciba), Nissan MT 239 (Nissan), acrylic polymers with glycidylic functionalities and epoxidic resins derived from bisphenol A;
vii) a mixture of carboxylate resins, as for example: carboxylate polyesters, acrylic carboxylates, polyanhydrides, and an amidine salt such as Vestagon B® 68 (the salt of a polycarboxylic acid and a cyclic amidine), where the ratio between the epoxidic equivalents and the carboxylic equivalents varies between 2 to 1 and 0.8 to 1 and the weight ratio between the epoxidic resin and the compound of the dicyandiamide family varies between 30 to 1 and 99 to 1.

21. The powder-base paint comprising a composition according to claim 19 or 20 as a binding agent and additional ingredients.

22. Supports treated using the paint according to claim 21.

23. Use of the composition according to claims 19 or 20 to produce powder-base paints that can be hardened by heat or using electromagnetic radiation such as UV light or an electronic beam.

24. Use of the composition according to claims 19 or 20 to produce powder-base paints to treat wood, glass, plastic, metal or paper.
